(19) United States
(12) Patent Application Publication
(10) Pub. No.: US 2017/0255382 A1
(43) Pub. Date: Sep. 7, 2017

(54) MOBILE TERMINAL AND OPERATION METHOD THEREOF AND COMPUTER STORAGE MEDIUM

(71) Applicant: NUBIA TECHNOLOGY CO., LTD., Shenzhen (CN)

(72) Inventors: Hanfei OU, Shenzhen (CN); Shian SHEN, Shenzhen (CN)

(73) Assignee: Nubia Technology Co., Ltd., Shenzhen (CN)

(21) Appl. No.: 15/506,771

(22) PCT Filed: Jul. 24, 2015
(86) PCT No.: PCT/CN2015/085060

§ 371 Date: Apr. 12, 2017

(30) Foreign Application Priority Data
Aug. 29, 2014 (CN) 201410438252.2

(51) Int. Cl. G06F 3/0488

(52) U.S. Cl. CPC G06F 3/04883; G06F 2203/04808; G06F 2203/04803

(57) ABSTRACT

Disclosed are a mobile terminal and an operation method therefor. The mobile terminal comprises a setting unit, a detection unit, a processing unit and a touch control screen, wherein the setting unit is used for dividing the touch control screen into a first touch control area and a second touch control area, and defining a corresponding relationship between a touch control action on the second touch control area and an operation instruction, the first touch control area being located in the front of the mobile terminal, and the second touch control area being located at an edge or/arid side of the mobile terminal; the detection unit is used for detecting the touch control action on the second touch control area; and the processing unit is used for executing the operation instruction corresponding to the touch control action according to the touch control action. Also disclosed is a computer storage medium.

### TECHNICAL FIELD

The present disclosure relates to the field of communications, and in particular, to a mobile terminal, an operation method therefor, and a computer storage medium.

### BACKGROUND

A touch control screen has been widely applied to a mobile terminal. A user may directly execute a touch control operation on the touch control screen. Compared with a traditional physical key operation instruction, the controllability of the touch control screen is high and the operation of the touch control screen is convenient. A touch control screen of an existing mobile terminal is only located in the front of the mobile terminal, a touch control operation cannot be executed at an edge, and due to arrangement of a physical key at a side, the touch control operation cannot be executed either. Therefore, the user may execute the touch control operation only on the touch control screen located in the front, thereby reducing the controllability and the operation convenience of the mobile terminal.

### SUMMARY

The embodiments of the present disclosure are expected to provide a mobile terminal, an operation method therefor, and a computer storage medium, intended to improve the controllability and the operation convenience of a mobile terminal, and improving the operation experience of a user.

According to a first aspect of the embodiments of the present disclosure, a mobile terminal is provided, which includes a setting unit, a detection unit, a processing unit and a touch control screen. The setting unit is arranged to divide the touch control screen into a first touch control area and a second touch control area, and define a correspondence relationship between a touch control action on the second touch control area and an operation instruction, the first touch control area being located in the front of the mobile terminal, and the second touch control area being located at an edge or/and side of the mobile terminal. The detection unit is arranged to detect the touch control action on the second touch control area. The processing unit is arranged to execute the operation instruction corresponding to the touch control action according to the touch control action.

Based on the above-mentioned solution, the touch control action includes a sliding action on a random position or preset position of the second touch control area, and the operation instruction is volume adjustment, screen luminance adjustment or switching between objects.

Based on the above-mentioned solution, the touch control action is a clicking action on a random position or preset position of the second touch control area, and the operation instruction includes initiation of a preset application, closing of a current application or achievement of a preset function.

Based on the above-mentioned solution, the second touch control area is located at left and right sides of the mobile terminal. The detection unit is arranged to detect number of contacts of the second touch control area at the left and right sides. The processing unit is arranged to identify whether a user holds the mobile terminal with a left hand or a right hand currently according to the number of contacts.

Based on the above-mentioned solution, the processing unit is further arranged to adjust a display layout of the mobile terminal according to a result of the identification about whether the user holds the mobile terminal with the left hand or the right hand currently.

Based on the above-mentioned solution, the touch control screen includes a backlight panel, a display panel, a touch control panel and a glass cover board stacked in sequence, and an edge of the glass cover board is arc-shaped to form the second touch control area.

Based on the above-mentioned solution, the detection unit is further arranged to detect a preset touch control action on the first touch control area. The processing unit is further arranged to trigger the second touch control area to initiate to receive touch and control from user input when the detection unit detects the preset touch control action on the first touch control area.

Based on the above-mentioned solution, the touch control screen includes a backlight panel, a display panel, a touch control panel and a glass cover board stacked in sequence, and edges of the backlight panel, the display panel, the touch control panel and the glass cover board are bent to be arc-shaped respectively to form the second touch control area.

Based on the above-mentioned solution, the processing unit is further arranged to unlock the mobile terminal when the mobile terminal is in a locked state and a preset touch control action on the second touch control area is detected.

According to a second aspect of the embodiments of the present disclosure, an operation method for a mobile terminal is also provided, which includes the following steps. A touch control screen is divided into a first touch control area and a second touch control area, wherein the first touch control area is located in the front of the mobile terminal, and the second touch control area is located at an edge or/and side of the mobile terminal. A correspondence relationship between touch control actions on the second touch control area and operation instructions is defined. A touch control action on the second touch control area is detected. An operation instruction corresponding to the touch control action is executed according to the touch control action.

Based on the above-mentioned solution, the touch control action includes a sliding action on a random position or preset position of the second touch control area, and the operation instruction is volume adjustment, screen luminance adjustment or switching between objects.

Based on the above-mentioned solution, the touch control action is a clicking action on a random position or preset position of the second touch control area, and the operation instruction includes initiation of a preset application, closing of a current application or achievement of a preset function.

Based on the above-mentioned solution, the second touch control area is located at left and right sides of the mobile terminal, and the operation method further includes that: number of contacts of the second touch control area at the left and right sides is detected; and it is identified whether a user holds the mobile terminal with a left hand or a right hand currently according to the number of contacts.

Based on the above-mentioned solution, the method further includes that: a display layout of the mobile terminal is adjusted according to a result of the identification about whether the user holds the mobile terminal with the left hand or the right hand currently.

Based on the above-mentioned solution, the method further includes that: a preset touch control action on the first touch control area is detected; and the second touch control area is triggered to initiate to receive touch and control from user input when the preset touch control action on the first touch control area is detected.

Based on the above-mentioned solution, the method further includes that: the mobile terminal is unlocked when the mobile terminal is in a locked state and a preset touch control action on the second touch control area is detected.

According to a third aspect of the embodiments of the present disclosure, a computer storage medium is also provided. Computer-executable instructions are stored in the computer storage medium. The computer-executable instructions are arranged to execute at least one of the methods according to the first aspect of the embodiments of the present disclosure.

According to the mobile terminal, the operation method for the mobile terminal and the computer storage medium provided by the embodiments of the present disclosure, the touch control screen extends to the edge or/and side of the mobile terminal to form the second touch control area, such that the user may execute a touch control operation on the second touch control area at the edge or side, and may customize a shortcut operation instruction for the second touch control area, thereby improving the controllability and the operation convenience of the mobile terminal, meeting an individual demand of the user, and improving the operation experience of the user.

In addition, when the second touch control area is located at the left and right sides of the mobile terminal, the mobile terminal also has a left hand and right hand identification function, namely a function of identifying whether the user holds the mobile, terminal with the left hand or the right hand currently, the display content and the display layout are automatically adjusted according to the identification result, so as to facilitate the usage operation of the user to the greatest extent, thus being more intelligent and humanized.

### BRIEF DESCRIPTION OF THE DRAWINGS

FIG 1 is a structural diagram of a mobile terminal according to an embodiment of the present disclosure.

FIG. 2 is a front view of a mobile terminal according to an embodiment of the present disclosure.

FIG. 3 is a side view of a mobile terminal according to an embodiment of the present disclosure.

FIG. 4 is an A-A section view of a mobile terminal in FIG. 2.

FIG. 5 is a structural diagram of a touch control screen of a mobile terminal according to an embodiment of the present disclosure.

FIG. 6 is a flowchart of an operation method for a mobile terminal according to an embodiment of the present disclosure.

FIG. 7 is a structural diagram of another mobile terminal according to an embodiment of the present disclosure.

FIG. 8 is a structural diagram of a communication system according to an embodiment of the present disclosure.

### DETAILED DESCRIPTION

Preferred embodiments of the present disclosure will be illustrated hereinbelow with the accompanying drawings. It should be understood that specific embodiments described herein are only intended to explain the present disclosure, and are not limitative of the present disclosure.

Referring to FIG. 1 to FIG. 5, a mobile terminal is provided by the embodiments of the present disclosure. The mobile terminal includes a setting module, a detection module, a processing unit and a touch control screen.

The setting unit is arranged to divide the touch control screen into a first touch control area and a second touch control area, and define a correspondence relationship between touch control actions on the second touch control area and operation instructions.

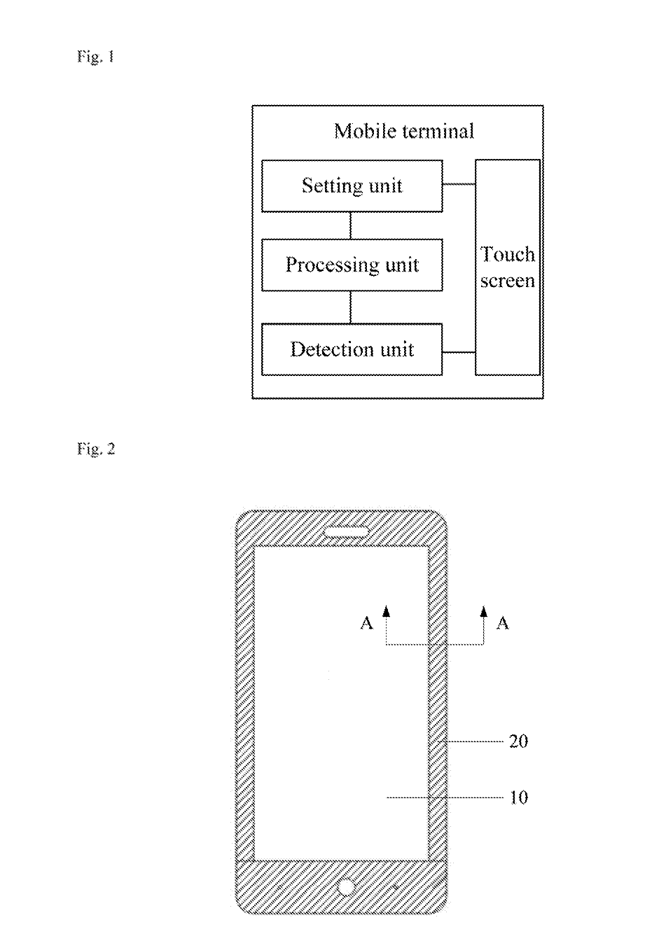

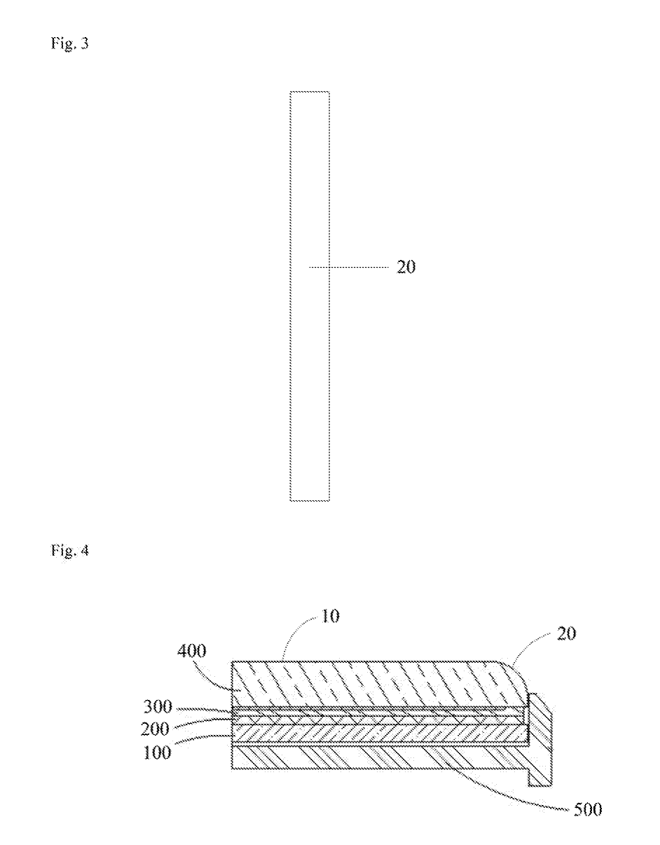

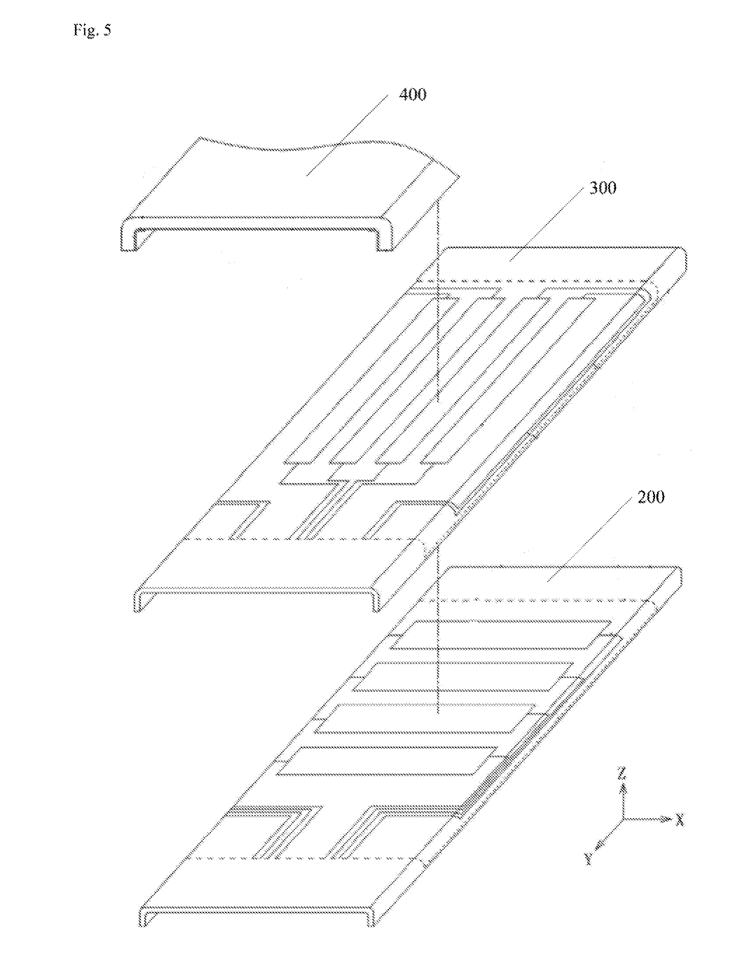

As shown in FIG. 2, the first touch control area is located in the front of the mobile terminal, and is a unique touch control area of the mobile terminal in the conventional art. As shown in FIG. 2 and FIG. 3, the second touch control area is located at an edge or/and side of the mobile terminal, and is an added touch control area in the present disclosure. A second touch control area may be provided at one edge or/and side of the mobile terminal, or second touch control areas may be provided at two, three or even four edges or/and sides of the mobile terminal respectively.

As shown in FIG. 4, the touch control screen includes a backlight panel, a display panel, a touch control panel and a glass cover board stacked in sequence, which are mounted into a middle frame (or panel). The glass cover board has a certain thickness, an edge thereof is arc-shaped by large circular arc transition, and the arc-shaped area forms the second touch control area, so the overall display of the mobile terminal presents a frameless effect, and a display range of the touch control screen extends to the edge or even side of the mobile terminal.

The structure of the touch control screen may also be as shown in FIG. 5. Edges of the backlight panel (not shown in the figure), the display panel, the touch control panel and the glass cover board are bent to be arc-shaped respectively to form the second touch control area. Since the glass cover board is bent to cover other panels, the side may not need to be covered by the middle frame, so the side of the touch control screen may be completely exposed, thereby increasing the area of the second touch control area at the side, more facilitating a touch control operation instruction of the user, and making the appearance more attractive and elegant.

Usually, a display area of the touch control screen is only limited to the range of the first touch control area. In some embodiments, the display area may extend to the second touch control area.

The touch control action includes a sliding action, a clicking action, etc., on the second touch control area. When the touch control action is a sliding action on a random position or preset position of the second touch control area, the corresponding operation instruction may be volume adjustment, screen luminance adjustment or switching between objects. When the touch control action is a clicking action on a random position or preset position of the second touch control area, the corresponding operation instruction may be initiation of a preset application, closing of a current application or achievement of a preset function.

The detection unit is arranged to detect a touch control action on the first touch control area and the second touch control area.

The processing unit is arranged to execute, according to the touch control action on the first touch control area and the second touch control area, a corresponding operation instruction. In particular, the processing unit executes the operation instruction corresponding to the current touch control action according to the touch control action on the second touch control area and a correspondence relationship, defined by the setting unit, between the touch control action on the second touch control area and the operation instruction.

For example, when the detection unit detects the sliding action on the second touch control area, the processing unit executes the corresponding operation instruction according to the sliding action. The operation instruction includes, for example, volume adjustment, screen luminance adjustment or switching between objects. A correspondence relationship between sliding actions and operation instructions may be set according to factory settings or customized by a user. For example, when the user slides the second touch control area at the edge or side of the mobile terminal up and down, volume is increased or decreased accordingly. When the user slides the second touch control area at the edge or side of the mobile terminal up and down, screen luminance is increased or decreased accordingly. When the user slides the second touch control area at the edge or side of the mobile terminal up and down, switching between objects is performed accordingly. During switching between objects, switched objects include a screen, a page, an application, a picture and the like, which depends on a currently used application or program. If a main screen is displayed currently, the screen is switched. If a page or document is being browsed currently, the page is switched. If a picture is being browsed currently, the picture is switched. If multiple applications are started currently, the multiple applications are switched mutually.

When the detection unit detects the clicking action on the random position or preset position of the second touch control area, the processing unit is arranged to execute the corresponding operation instruction according to the clicking action. The operation instruction may include initiation of a preset application, closing of a current application or achievement of a preset function. A correspondence relationship between clicking actions and operation instructions may be set according to factory settings or customized by a user. For example, when the user singly clicks the random position or preset position of the second touch control area at the edge or side of the mobile terminal, a certain application is initiated. When the user doubly clicks the random position or preset position of the second touch control area at the edge or side of the mobile terminal, the current application is closed. When the user singly clicks the random position or preset position of the second touch control area at the edge or side of the mobile terminal, a preset function is achieved, which include a hand-free function for communication, a full-screen function for video watching, an enlargement or shrinkage function for picture browsing, a screen-on or screen-off function, etc.

Alternatively, when the second touch control area is located at left and right sides of the mobile terminal, the detection unit is arranged to detect number of contacts of the second touch control area at the left and right sides when the user holds the mobile terminal with a hand, and the processing unit is arranged to identity whether the hand is a left hand or a right hand according to the number of contacts, namely identify whether the user holds the mobile terminal with a left hand or a right hand currently. A display content and/or a display layout are adjusted according to a result of the identification, so as to facilitate the usage operation of the user to the greatest extent, thus being more intelligent and humanized. For example, if it is detected that there is a contact in the second touch control area at the right side and there are at least two contacts in the second touch control area at the left side, it is identified that the user holds the mobile terminal with the right hand currently, otherwise, it is identified that the user holds the mobile terminal with the left hand currently. The display layout here may include a display position of an operation control displayed on a display screen. When the user holds a mobile terminal such as a large-screen mobile phone with a single hand, the user will operate the mobile terminal with a thumb usually. In this case, the operation control may include a return control, a determination control or a cancelation control, and the display layout includes arrangement of the display position of the above mentioned operation control, such that the display position of the operation control shifts to the hand holding the mobile terminal. If the display position is far away from the thumb of the user, the user will be forced to switch a single-hand operation to a double-hand operation, so the usage comfort of the user will be reduced apparently. In the present embodiment, the above-mentioned problem is well solved by intelligently identifying whether the user holds an electronic device with a left hand or a right hand and adjusting the display layout according to the identification result.

Generally, only when the mobile terminal is in a screen-on state (i.e., unlocked state), the user may execute a touch control operation on the first touch control area and the second touch control area. In some embodiments, even if the mobile terminal is in a screen-off state (i.e., locked state), the user may also execute a touch control operation on the second touch control area. For example, the processing unit is further arranged to unlock the mobile terminal and/or initiate a preset application when the detection unit detects a preset touch control action on the random position or preset position of the second touch control area.

In view of that it is easy to touch the second touch control area at the side of the mobile terminal to cause false operation when the mobile terminal is held in a hand, a trigger condition for the second touch control area may be further set. When the detection unit detects the preset touch control action on the first touch control area or the second touch control area, the processing unit triggers the second touch control area. Only at this time, the user can touch and control the second touch control area to initiate a preset application or execute a preset function. The processing unit is arranged to trigger the second touch control area to initiate to receive touch and control from user input when the trigger condition is satisfied.

The touch control operation on the first touch control area belongs to the conventional art, which will not be elaborated herein.

Thus, according to the mobile terminal in the embodiments of the present disclosure, the touch control screen extends to the edge or/and side of the mobile terminal to form the second touch control area, such that the user may execute the touch control operation on the second touch control area at the edge or side, and may customize a shortcut operation instruction for the second touch control area, thereby improving the controllability and the operation convenience of the mobile terminal, meeting an individual demand of the user, and improving the operation experience of the user.

In addition, when the second touch control area is located at the left and right sides of the mobile terminal, the mobile terminal also has a left hand and right hand identification function, namely a function of identifying whether the user holds the mobile terminal with the left hand or the right hand currently, the display content and the display layout are automatically adjusted according to the identification result, so as to facilitate the usage operation of the user to the greatest extent, thus being more intelligent and humanized.

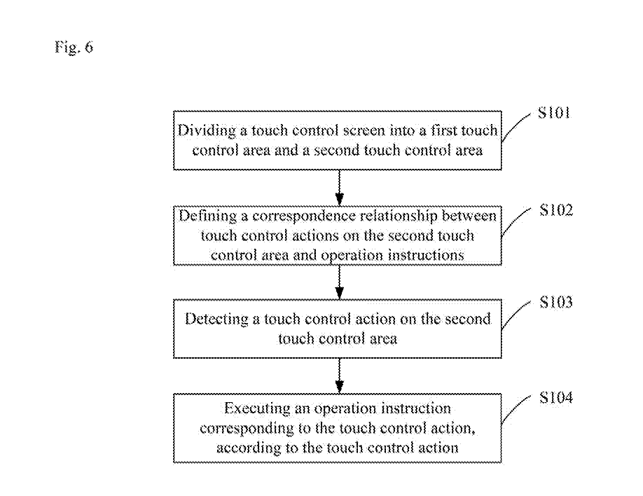

Referring to FIG. 6, an operation method for a mobile terminal is provided in the embodiments of the present disclosure. The operation method includes the following steps.

At step S101, a touch control screen is divided into a first touch control area and a second touch control area.

As shown in FIG. 2, the first touch control area is located in the front of the mobile terminal, and is a unique touch control area of the mobile terminal in the conventional art. As shown in FIG. 2 and FIG. 3, the second touch control area is located at an edge or/and side of the mobile terminal, and is an added touch control area in the present disclosure. A second touch control area may be provided at one edge or/and side of the mobile terminal, or second touch control areas may be provided at two, three or even four edges or/and sides of the mobile terminal respectively. Usually, a display area of a touch control screen is only limited to the range of the first touch control area. In some embodiments, the display area may also extend to the second touch control area.

At step S102, a correspondence relationship between touch control actions on the second touch control area and operation instructions is defined.

The touch control action includes a sliding action, a clicking action, etc., on the second touch control area. When the touch control action is a sliding action on a random position or preset position of the second touch control area, the corresponding operation instruction may be volume adjustment, screen luminance adjustment or switching between objects. When the touch control action is a clicking action on a random position or preset position of the second touch control area, the corresponding operation instruction may be initiation of a preset application, closing of a current application or achievement of a preset function.

At step S103, the touch control action on the second touch control area is detected.

At step S104, the operation instruction corresponding to the touch control action is executed according to the touch control action.

For example, when the sliding action on the second touch control area is detected, the corresponding operation instruction is executed according to the sliding action. The operation instruction includes, for example, volume adjustment, screen luminance adjustment or switching between objects and the like. A correspondence relationship between sliding actions and operation instructions may be set according to factory settings or customized by a user. For example, when the user slides the second touch control area at the edge or side of the mobile terminal up and down, volume is increased or decreased accordingly. When the user slides the second touch control area at the edge or side of the mobile terminal up and down, screen luminance is increased or decreased accordingly. When the user slides the second touch control area at the edge or side of the mobile terminal up and down, switching between objects is performed accordingly. During switching between objects, switched objects include a screen, a page, an application, a picture and the like, which depends on a currently used application or program. If a main screen is displayed currently, the screen is switched. If a page or document is being browsed currently, the page is switched. If a picture is being browsed currently, the picture is switched. If multiple applications are started currently, the multiple applications are switched mutually.

When the clicking action on the random position or preset position of the second touch control area is detected, the corresponding operation instruction is executed according to the clicking action. The operation instruction includes initiation of a preset application, closing of a current application or achievement of a preset function. A correspondence relationship between clicking actions and operation instructions may be set according to factory settings or customized by a user. For example, when the user singly clicks the random position or preset position of the second touch control area at the edge or side of the mobile terminal, a certain application is initiated. When the user doubly clicks the random position or preset position of the second touch control area at the edge or side of the mobile terminal, the current application is closed. When the user singly clicks the random position or preset position of the second touch control area at the edge or side of the mobile terminal, a preset function is achieved which includes a hand-free function for communication, a full-screen function for video watching, an enlargement or shrinkage function for picture browsing, a screen-on or screen-off function, etc.

Alternatively, when the second touch control area is located at left and right sides of the mobile terminal, number of contacts of the second touch control area at the left and right sides when the user holds the mobile terminal with a hand is detected, and it is identified whether the hand is a left hand or a right hand according to the number of contacts, namely whether the user holds the mobile terminal with a left hand or a right hand currently. A display content and/or a display layout are adjusted according to a result of the identification, so as to facilitate the usage operation of the user to the greatest extent, thus being more intelligent and humanized. For example, if it is detected that there is a contact in the second touch control area at the right side and there are at least two contacts in the second touch control area at the left side, it is identified that the user holds the mobile terminal with the right hand currently, otherwise, it is identified that the user holds the mobile terminal with the left hand currently. Generally, only when the mobile terminal is in a screen-on state (i.e., unlocked state), the user may execute a touch control operation on the first touch control area and the second touch control area. In some embodiments, even if the mobile terminal is in a screen-off state (i.e., locked state), the user may also execute a touch control operation on the second touch control area. For example, the mobile terminal is unlocked and/or a preset application is initiated when a preset touch control action on the random position or preset position of the second touch control area is detected. In this way, the method in the present embodiment implements unlocking the mobile terminal when the mobile terminal is in a locked state and the preset touch control action on the second touch control area is detected.

In view of that it is easy to touch the second touch control area at the side of the mobile terminal to cause false operation when the mobile terminal is held in a hand, a trigger condition for the second touch control area may be further set. When the preset touch control action on the first touch control area or the second touch control area is detected, the second touch control area is triggered to initiate to receive touch and control from user input. At this time, the user can touch and control the second touch control area to initiate a preset application or execute a preset function.

Thus, according to the operation method for the mobile terminal in the present disclosure, the touch control screen extends to the edge or/and side of the mobile terminal to form the second touch control area, such that the user may execute the touch control operation on the second touch control area at the edge or side, and may customize a shortcut operation instruction for the second touch control area, thereby improving the controllability and the operation convenience of the mobile terminal, meeting an individual demand of the user, and improving the operation experience of the user.

In addition, when the second touch control area is located at the left and right sides of the mobile terminal, the mobile terminal also has a left hand and right hand identification function, namely a function of identifying whether the user holds the mobile terminal with the left hand or the right hand currently, the display content and the display layout are automatically adjusted according to the identification result, so as to facilitate the usage operation of the user to the greatest extent, thus being more intelligent and humanized.

The embodiments of the present disclosure also provide a computer storage medium. Computer-executable instructions are stored in the computer storage medium. The computer-executable instructions are arranged to execute at least one of the aforementioned methods, e.g., the method as shown in FIG. 6.

The storage medium may be a Read-Only Memory/Random Access Memory (ROM/RAM), a magnetic disk, an optical disc, a U disk or a mobile hard disk, and may be a non-transient storage medium preferably.

The mobile terminal according to embodiments of the present disclosure will now be described with reference to the accompanying drawings. In the following description, usage of suffixes such as ‘module’, ‘part’ or ‘unit’ used for referring to elements is given merely to facilitate explanation of the present disclosure, without having any significant meaning by itself. Accordingly, the ‘module’ and ‘part’ may be mixedly used.

Mobile terminals may be implemented in various forms. For example, the terminal described in the present disclosure may include mobile terminals such as mobile phones, smart phones, notebook computers, digital broadcast receivers, PDAs (Personal Digital Assistants), PMPs (Portable Multimedia Player), navigation devices and the like, and fixed terminals such as digital TVs, desk top computers and the like. Hereinafter, it is assumed that the terminal is a mobile terminal. However, it would be understood by a person in the art that the configuration according to the embodiments of the present disclosure can be also applicable to the fixed types of terminals, except for any elements especially configured for a mobile purpose.

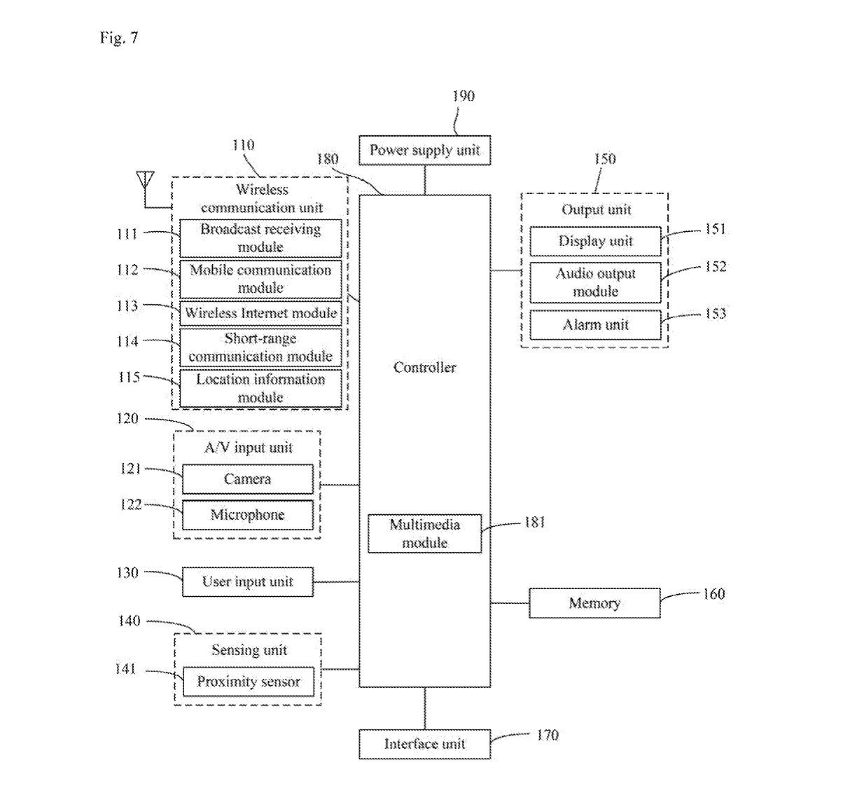

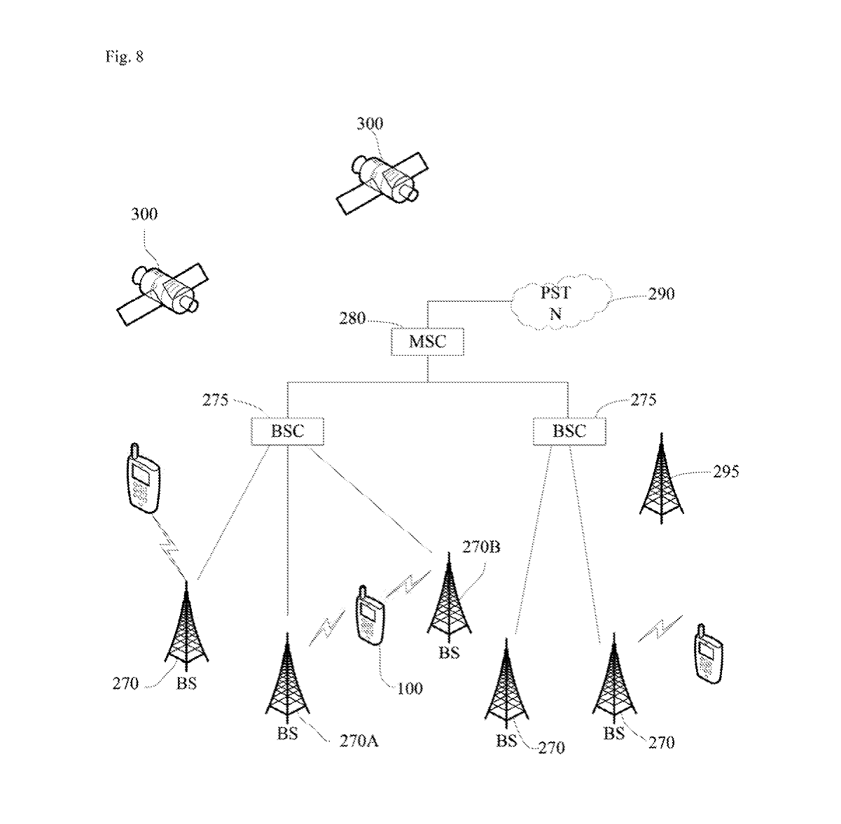

FIG. 7 is a hardware structure diagram of a mobile terminal according to each embodiment of the present disclosure.

The mobile terminal may include a wireless communication unit 110, an A/V (Audio/Video) input unit 120, a user input unit 130, a sensing unit 140, an output unit 150, a memory 160, an interface unit 170, a controller 180, a power supply unit 190 and the like. FIG. 7 shows the mobile terminal as having various components, but it should be understood that implementing all of the illustrated components is not a requirement. Greater or fewer components may alternatively be implemented. The elements of the mobile terminal will be described in details below.

The wireless communication unit 110 typically includes one or more components allowing radio communication between the mobile terminal and a wireless communication system or a network. For example, the wireless communication unit may include at least one of a broadcast receiving module 111, a mobile communication module 112, a wireless Internet module 113, a short-range communication module 114, and a location information module 115.

The broadcast receiving module 111 receives broadcast signals and/or broadcast associated information from an external broadcast management server via a broadcast channel. The broadcast channel may include a satellite channel and/or a terrestrial channel. The broadcast management server may be a server that generates and transmits a broadcast signal and/or broadcast associated information or a server that receives a previously generated broadcast signal and/or broadcast associated information and transmits the same to a terminal. The broadcast signal may include a TV broadcast signal, a radio broadcast signal, a data broadcast signal, and the like. Also, the broadcast signal may further include a broadcast signal combined with a TV or radio broadcast signal. The broadcast associated information may also be provided via a mobile communication network and, in this instance, the broadcast associated information may be received by the mobile communication module 112. The broadcast signal may exist in various forms. For example, it may exist in the form of an electronic program guide (EPG) of digital multimedia broadcasting (DMB), electronic service guide (ESG) of digital video broadcast-handheld (DVB-H), and the like. The broadcast receiving module 111 may be configured to receive signals broadcast by using various types of broadcast systems. In particular, the broadcast receiving module 111 may receive a digital broadcast by using a digital broadcast system such as multimedia broadcasting-terrestrial (DMB-T), digital multimedia broadcasting-satellite (DMB-S), digital video broadcast-handheld (DVB-H), the data broadcasting system known as media forward link only (MediaFLO^{@}), integrated services digital broadcast-terrestrial (ISDB-T), etc. The broadcast receiving module 111 may be configured to be suitable for every broadcast system that provides a broadcast signal as well as the above-mentioned digital broadcast systems. Broadcast signals and/or broadcast-associated information received via the broadcast receiving module 111 may be stored in the memory 160 (or another type of storage medium).

The mobile communication modules 112 transmits and/or receives radio signals to and/or from at least one of a base station (e.g., access point, Node B, etc.), an external terminal and a server. Such radio signals may include a voice call signal, a video call signal or various types of data according to text and/or multimedia message transmission and/or reception.

The wireless Internet module 113 supports wireless Internet access for the mobile terminal. This module may be internally or externally coupled to the terminal. The wireless Internet access technique implemented may include a WLAN (Wireless LAN) (Wi-Fi), Wibro (Wireless broadband), Wimax (World Interoperability for Microwave Access), HSDPA (High Speed Downlink Packet Access), or the like.

The short-range communication module 114 is a module for supporting short range communications. Some examples of short-range communication technology include Bluetooth™, Radio Frequency IDentification (REID), Infrared Data Association (IrDA), Ultra-WideBand (UWB), Zigbee™, and the like.

The location information module 115 is a module for checking or acquiring a location of the mobile terminal. A typical example of the location information module is a GPS (Global Positioning System). According to the current technology, the GPS module 115 calculates distance information from three or more satellites and accurate time information and applies trigonometry to the calculated information to thereby accurately calculate three-dimensional current location information according to latitude, longitude, and altitude. Currently, a method for calculating location and time information by using three satellites and correcting an error of the calculated location and time information by using another one satellite is provided. In addition, the GPS module 115 can calculate speed information by continuously calculating the current location in real time.

The A/V input unit 120 is configured to receive an audio or video signal. The A/V input unit 120 may include a camera 121 and a microphone 1220. The camera 121 processes image data of still pictures or video obtained by an image capture device in a video capturing mode or an image capturing mode. The processed image frames may be displayed on a display unit 151. The image frames processed by the camera 121 may be stored in the memory 160 (or other storage medium) or transmitted via the wireless communication unit 110. Two or more cameras 1210 may be provided according to the configuration of the mobile terminal. The microphone 122 may receive sounds (audible data) via a microphone in a phone call mode, a recording mode, a voice recognition mode, and the like, and can process such sounds into audio data. The processed audio (voice) data may be converted for output into a format transmittable to a mobile communication base station via the mobile communication module 112 during the phone call mode. The microphone 122 may implement various types of noise canceling (or suppression) algorithms to cancel (or suppress) noise or interference generated in the course of receiving and transmitting audio signals.

The user input unit 130 may generate key input data from commands entered by a user to control various operations of the mobile terminal. The user input unit 130 allows the user to enter various types of information, and may include a keypad, a dome switch, a touch pad (e.g., a touch sensitive member that detects changes in resistance, pressure, capacitance, etc. due to being contacted), a jog wheel, a jog switch, and the like. In particular, when the touch pad is overlaid on the display unit 151 in a layered manner, it may form a touch screen.

The sensing unit 140 detects a current status of the mobile terminal such as an opened or closed state of the mobile terminal, a location of the mobile terminal, the presence or absence of user contact with the mobile terminal (i.e., touch inputs), the orientation of the mobile terminal, an acceleration or deceleration movement and direction of the mobile terminal, etc., and generates commands or signals for controlling the operation of the mobile terminal. For example, when the mobile terminal is implemented as a slide type mobile phone, the sensing unit 140 may sense whether the slide phone is opened or closed. In addition, the sensing unit 140 can detect whether or not the power supply unit 190 supplies power or whether or not the interface unit 170 is coupled with an external device. The sensing unit 140 may include a proximity sensor 141. This will be described in relation to a touch screen later.

The interface unit 170 serves as an interface by which at least one external device may be connected with the mobile terminal. For example, the external devices may include wired or wireless headset ports, an external power supply (or battery charger) ports, wired or wireless data ports, memory card ports, ports for connecting a device having an identification module, audio input/output (I/O) ports, video I/O ports, earphone ports, or the like. The identification module may be a memory chip that stores various information for authenticating a user's authority for using the mobile terminal and may include a user identity module (UIM), a subscriber identity module (SIM), a universal subscriber identity module (USIM), and the like. In addition, the device having the identification module (referred to as the ‘identifying device’, hereinafter) may take the form of a smart card. Accordingly, the identifying device may be connected with the terminal via a port or other connection means. The interface unit 170 may be used to receive inputs (e.g., data, information, power, etc.) from an external device and transfer the received inputs to one or more elements within the mobile terminal or may be used to transfer data between the mobile terminal and an external device.

In addition, when the mobile terminal is connected with an external cradle, the interface unit 170 may serve as a conduit to allow power from the cradle to be supplied therethrough to the mobile terminal or may serve as a conduit to allow various command signals input from the cradle to be transferred to the mobile terminal therethrough. Various command signals or power input from the cradle may be operated as a signal for recognizing whether the mobile terminal is accurately mounted on the cradle. The output unit 150 is configured to provide outputs in a visual, audible, and/or tactile manner (e.g., audio signal, video signal, alarm signal, vibration signal, etc.). The output unit 150 may include the display unit 151, an audio output module 152, an alarm unit 153, and the like.

The display unit 151 may display information processed in the mobile terminal. For example, when the mobile terminal is in a phone call mode, the display unit 151 may display a User Interface (UI) or a Graphic User Interface (GUI) associated with a call or other communication (such as text messaging, multimedia file downloading, etc.). When the mobile terminal is in a video call mode or image capturing mode, the display unit 151 may display a captured image and/or received image, a UI or GUI that shows videos or images and functions related thereto, and the like.

Meanwhile, when the display unit 151 and the touch pad are overlaid in a layered manner to form a touch screen, the display unit 151 may function as both an input device and an output device. The display unit 151 may include at least one of a Liquid Crystal Display (LCD), a Thin Film Transistor-LCD (TFT-LCD), an Organic Light Emitting Diode (OLED) display, a flexible display, a three-dimensional (3D) display, or the like. Some of them may be configured to be transparent to allow viewing of the exterior, which may be called transparent displays. A typical transparent display may be, for example, a TOLED (Transparent Organic Light Emitting Diode) display, or the like. The mobile terminal may include two or more display units (or other display means) according to its particular desired embodiment. For example, the mobile terminal may include both an external display unit (not shown) and an internal display unit (not shown). The touch screen may be configured to detect even a touch input pressure as well as a touch input position and a touch input area.

The audio output module 152 may convert and output as sound audio data received from the wireless communication unit 110 or stored in the memory 160 in a call signal reception mode, a call mode, a record mode, a voice recognition mode, a broadcast reception mode, and the like. Also, the audio output module 152 may provide audible outputs related to a particular function performed by the mobile terminal (e.g., a call signal reception sound, a message reception sound, etc.). The audio output module 152 may include a speaker, a buzzer, or the like,

The alarm unit 153 may provide outputs to inform about the, occurrence of an event of the mobile terminal. Typical events may include call reception, message reception, key signal inputs, a touch input etc. In addition to audio or video outputs, the alarm unit 153 may provide outputs in a different manner to inform about the occurrence of an event. For example, the alarm unit 153 may provide an output in the form of vibrations. When a call, a message, or some other incoming communication is received, the alarm unit 153 may provide tactile outputs (i.e., vibrations) to inform the user thereof. By providing such tactile outputs, the user can recognize the occurrence of various events even if his mobile phone is in the user's pocket. Outputs informing about the occurrence of an event may be also provided via the display unit 151 or the audio output module 152 by the alarm unit 153.

The memory 160 may store software programs or the like used for the processing and controlling operations performed by the controller 180, or may temporarily store data (e.g., is phonebook, messages, still images, video, etc.) that have been output or which are to be output. Also, the memory 160 may store data regarding various patterns of vibrations and audio signals output when a touch is applied to the touch screen.

The memory 160 may include at least one type of storage medium including a Flash memory, a hard disk, a multimedia card, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disk, an optical disk, and the like. Also, the mobile terminal may cooperate with a network storage device that performs the storage function of the memory 160 over a network connection.

The controller 180 typically controls the general operations of the mobile terminal. For example, the controller 180 performs controlling and processing associated with voice calls, data communications, video calls, and the like. In addition, the controller 180 may include a multimedia module 1810 for reproducing (or playing back) multimedia data. The multimedia module 1810 may be configured within the controller 180 or may be configured to be separate from the controller 180. The controller 180 may perform a pattern recognition processing to recognize a handwriting input or a picture drawing input performed on the touch screen as characters or images.

The power supply unit 190 receives, external power or internal power and supplies appropriate power required for operating respective elements and components under the control of the controller 180.

Various embodiments as described herein may be implemented in a computer-readable, medium using, for example, computer software, hardware, or any combination thereof. For hardware implementation, the embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic units designed to perform the functions described herein. In some instances, such embodiments may be implemented in the controller 180. For software implementation, the embodiments such as procedures or functions may be implemented together with separate software modules that allow performing of at least one function or operation. Software codes can be implemented by a software application (or program) written in any suitable programming language. The software codes may be stored in the memory 160 and executed by the controller 180.

So far, the mobile terminal has been described from the perspective of its functions. Hereinafter, a slide-type mobile terminal, among various types of mobile terminal such as folder-type, bar-type, swing-type, slide type mobile terminals, or the like, will be described as an example for the sake of brevity. Thus, the present disclosure can be applicable to any type of mobile terminal, without being limited to the slide-type mobile terminal.

The mobile terminal as shown in FIG. 7 may be configured to operate with a communication system, which transmits data via frames or packets, such as wired and wireless communication systems, as well as satellite-based communication systems.

Such communication systems in which the mobile terminal according to an embodiment of the present disclosure can operate will now be described with reference to FIG. 8.

These communication systems may use different air interfaces and/or physical layers. For example, air interfaces utilized by the communication systems include, for example, frequency division multiple access (FDMA), time division multiple access (TDMA), code division multiple access (CDMA), and universal mobile telecommunications system (UMTS) (in particular, long term evolution (LTE)), global system for mobile communications (GSM), and the like. As a non-limiting example, the description hereafter relates to a CDMA communication system, but such teachings apply equally to other types of systems.

Referring to FIG. 8, a CDMA wireless communication system may include a plurality of mobile terminals, a plurality of base stations (BSs) 270, base station controllers (BSCs) 275, and a mobile switching center (MSC) 280. The MSC 280 is configured to interface with a public switch telephone network (PSTN) 290. The MSC 280 is also configured to interface with the BSCs 275, which may be coupled to the base stations 270 via backhaul lines. The backhaul lines may be configured in accordance with any of several known interfaces including, for example, E1/T1, ATM, IP, PPP, Frame Relay, HDSL, ADSL, or xDSL. It is to be understood that the system as shown in FIG. 2 may include a plurality of BSCs 2750.

Each BS 270 may serve one or more sectors (or regions), each sector covered by an omni-directional antenna or an antenna pointed in a particular direction radially away from the BS 270. Alternatively, each sector may be covered by two or more antennas for diversity reception. Each BS 270 may be configured to support a plurality of frequency assignments, and each frequency assignment has a particular spectrum (e.g., 1.25 MHz, 5 MHz, etc).

The intersection of a sector and frequency assignment may be referred to as a CDMA channel. The BS 270 may also be referred to as base station transceiver subsystems (BTSs) or other equivalent terms. In this situation, the term “base station” may be used to collectively refer to a single BSC 275 and at least one BS 270. The base station may also be referred to as a “cell site”. Alternatively, individual sectors of a particular BS 270 may be referred to as a plurality of cell sites.

As shown in FIG. 2, a broadcasting transmitter (BT) 295 transmits a broadcast signal to the mobile terminals operating within the system. The broadcast receiving module 111 as shown in FIG. 7 is provided at the terminal to receive broadcast signals transmitted by the BT 295. In FIG. 2, several global positioning systems (GPS) satellites 300 are shown. The satellites 300 help locate at least one of a plurality of terminals.

In FIG. 8, several satellites 300 are depicted, but it is understood that useful positioning information may be obtained with any number of satellites. The GPS module 115 as shown in FIG. 7 is typically configured to cooperate with the satellites 300 to obtain desired positioning information. Instead of or in addition to GPS tracking techniques, other technologies that may track the location of the mobile terminals may be used. In addition, at least one of the GPS satellites 300 may selectively or additionally handle satellite DMB transmissions.

As one typical operation of the wireless communication system, the BSs 270 receive reverse-link signals from various mobile terminals. The mobile terminals typically engage in calls, messaging, and other types of communications. Each reverse-link signal received by a particular base station 270 is processed within the particular BS 270. The resulting data is forwarded to an associated BSC 275. The BSC provides call resource allocation and mobility management functionality including the coordination of soft handoff procedures between BSs 270. The BSCs 275 also route the received data to the MSC 280, which provides additional routing services for interfacing with the PSTN 290. Similarly, the PSTN 290 interfaces with the MSC 280, the MSC interfaces with the BSCs 275, and the BSCs 275 in turn control the BSs 270 to transmit forward-link signals to the mobile terminals.

Those of ordinary skilled in the art may understand that all or some steps in the above-mentioned embodiment method may be completed by controlling relevant hardware via a program which may be stored in a computer-readable storage medium which may be an ROM/RAM, a magnetic disk, an optical disc or the like.

It should be understood that the above is only the preferred embodiments of the present disclosure, and are thus not limitative of the patent scope of the present disclosure. All modifications made according to the principle of the present disclosure should be interpreted as falling within the scope of protection of the present disclosure.

1. A mobile terminal comprising a processor, a memory for storing instructions executable by the processor and a touch control screen, wherein the processor is arranged to:
divide the touch control screen into a first touch control area and a second touch control area, and define a correspondence relationship between touch control actions on the second touch control area and operation instructions, the first touch control area being located in the front of the mobile terminal, and the second touch control area being located at an edge or/and side of the mobile terminal;
detect a touch control action on the second touch control area; and
execute an operation instruction corresponding to the touch control action according to the touch control action.

2. The mobile terminal according to claim 1, wherein the touch control action is a sliding action on a random position or present position of the second touch control area, and the operation instruction comprises volume adjustment, screen luminance adjustment or switching between objects.

3. The mobile terminal according to claim 1, wherein the touch control action is a clicking action on a random position or preset position of the second touch control area, and the operation instruction comprises initiation of a preset application, closing of a current application or achievement of a preset function.

4. The mobile terminal according to claim 1, wherein the second touch control area is located at left and right sides of the mobile terminal, the processor is further arranged to:
detect number of contacts of the second touch control area at the left and right sides; and
identify whether a user holds the mobile terminal with a left hand or a right hand currently according to the number of contacts.

5. The mobile terminal according to claim 4, wherein the processor is further arranged to:
adjust a display layout of the mobile terminal according to a result of the identification about whether the user holds the mobile terminal with the left hand or the right hand currently.

6. The mobile terminal according to claim 1, wherein the touch control screen comprises a backlight panel, a display panel, a touch control panel and a glass cover board stacked in sequence, and an edge of the glass cover board is arc-shaped to form the second touch control area.

7. The mobile terminal according to claim 1, wherein the processor is further arranged to:
detect a preset touch control action on the first touch control area; and
trigger the second touch control area to initiate to receive touch and control from user input when detecting the preset touch control action on the first touch control area.

8. The mobile terminal according to claim 1, wherein the touch control screen comprises a backlight panel, a display panel, a touch control panel and a glass cover board stacked in sequence, and edges of the backlight panel, the display panel, the touch control panel and the glass cover board are bent to be arc-shaped respectively to form the second touch control area.

9. The mobile terminal according to claim 1, wherein the processor is further arranged to:
unlock the mobile terminal when the mobile terminal is in a locked state and a preset touch control action on the second touch control area is detected.

10. An operation method for a mobile terminal, comprising:
dividing a touch control screen into a first touch control area and a second touch control area, wherein the first touch control area is located in the front of the mobile terminal, and the second touch control area is located at an edge or/and side of the mobile terminal;
defining a correspondence relationship between touch control actions on the second touch control area and operation instructions;
detecting a touch control action on the second touch control area; and
executing an operation instruction corresponding to the touch control action according to the touch control action.

11. The operation method according to claim 10, wherein the touch control action is a sliding action on a random position or preset position of the second touch control area, and the operation instruction comprises volume adjustment, screen luminance adjustment or switching between objects.

12. The operation method according to claim 10, wherein the touch control action is a clicking action on a random position or preset position of the second touch control area, and the operation instruction comprises initiation of a preset application, closing of a current application or achievement of a preset function.

13. The operation method according to claim 10, wherein the second touch control area is located at left and right sides of the mobile terminal, and the operation method further comprises:
detecting number of contacts of the second touch control area at the left and right sides; and
identifying whether a user holds the mobile terminal with a left hand or a right hand currently according to the number of contacts.

14. The operation method according to claim 13, wherein
the method comprises:
adjusting a display layout of the mobile terminal according to a result of the identification about whether the user holds the mobile terminal with the left hand or the right hand currently.

15. The operation method according to claim 10, wherein
the method further comprises:
detecting a preset touch control action on the first touch control area; and
triggering the second touch control area to initiate to receive touch and control from user input when the preset touch control action on the first touch control area is detected.

16. The operation method according to claim 10, wherein
the method further comprises:
unlocking the mobile terminal when the mobile terminal is in a locked state and a preset touch control action on the second touch control area is detected.

17. A non-transient computer storage medium having stored thereon computer-executable instructions for executing an operation method for a mobile terminal, the method comprising:
dividing a touch control screen into a first touch control area and a second touch control area, wherein the first touch control area is located in the front of the mobile terminal, and the second touch control area is located at an edge or/and side of the mobile terminal;
defining a correspondence relationship between touch control actions on the second touch control area and operation instructions;
detecting a touch control action on the second touch control area; and
executing an operation instruction corresponding to the touch control action according to the touch control action.

18. The mobile terminal according to claim 2, wherein the processor is further arranged to:
unlock the mobile terminal when the mobile terminal is in a locked state and a preset touch control action on the second touch control area is detected.

19. The mobile terminal according to claim 3, wherein the processor is further arranged to:
unlock the mobile terminal when the mobile terminal is in a locked state and a preset touch control action on the second touch control area is detected.

20. The mobile terminal according to claim 4, wherein the processor is further arranged to:
unlock the mobile terminal when the mobile terminal is in a locked state and a preset touch control action on the second touch control area is detected.
